(19) United States
(12) Patent Application Publication
(10) Pub. No.: US 2025/0263852 A1
(43) Pub. Date: Aug. 21, 2025

(54) ELECTROCHEMICAL CELL

(71) Applicant: NGK INSULATORS, LTD., Nagoya-shi (JP)

(72) Inventors: Naoya AKIYAMA, Nagoya-shi (JP); Kazuhiro MIZUKI, Kuwana-shi (JP); Shiko IWASAKI, Nagoya-shi (JP); Shinji FUJISAKI, Kuwana-shi (JP); Makoto OHMORI, Nagoya-shi (JP)

(21) Appl. No.: 19/199,630

(22) Filed: May 6, 2025

Related U.S. Application Data
(63) Continuation of application No. PCT/JP2023/041814, filed on Nov. 21, 2023.

(30) Foreign Application Priority Data
Dec. 6, 2022 (JP) 2022-195067

(51) Int. Cl. C25B 9/63; C25B 11/031; C25B 11/037; C25B 11/046; H01M 8/0273

(52) U.S. Cl. CPC C25B 9/63; C25B 11/031; C25B 11/037; C25B 11/046; H01M 8/0273

(57) ABSTRACT

An electrochemical cell according to a first aspect of the present invention includes a support body, a first electrode layer, an electrolyte layer, and a second electrode layer. The first electrode layer is disposed on the support body. The electrolyte layer is disposed on the first electrode layer. The second electrode layer is disposed on the side opposite to the first electrode layer with respect to the electrolyte layer. The support body has a current collecting layer and a beam portion embedded in the current collecting layer. The first electrode layer includes an overlapping portion that overlaps the beam portion in a stacking direction, and a non-overlapping portion that does not overlap the beam portion in the stacking direction. The average particle size of Ni particles contained in the overlapping portion is smaller than the average particle size of Ni particles contained in the non-overlapping portion.

### CROSS-REFERENCE TO RELATED APPLICATION

This is a continuation of PCT/JP2023/041814, filed Nov. 21, 2023, which claims priority from Japanese Application No. 2022-195067, filed Dec. 6, 2022 the entire content of which is hereby incorporated by reference.

### TECHNICAL FIELD

The present invention relates to an electrochemical cell.

### BACKGROUND ART

There have been conventionally known electrode-supported electrochemical cells (electrolytic cells, fuel cells, and the like) that have an electrolyte layer interposed between two electrode layers, one of which functions as a support body.

For example, JP 2014-049322A discloses an anode-supported fuel cell in which, out of the anode, the cathode, and the electrolyte, the anode is the thickest, and the anode functions as a support body.

### SUMMARY

However, even if the thickness of the electrode layer functioning as a support body is increased, it is difficult to obtain sufficient rigidity because the electrode layer is porous. Therefore, the electrochemical cell may become warped as the temperature rises and falls during reduction treatment or operation.

An object of the present invention is to provide an electrochemical cell that is capable of suppressing warping.

An electrochemical cell according to a first aspect of the present invention includes a support body, a first electrode layer, an electrolyte layer, and a second electrode layer. The first electrode layer is disposed on the support body. The electrolyte layer is disposed on the first electrode layer. The second electrode layer is disposed on the side opposite to the first electrode layer with respect to the electrolyte layer. The support body has a current collecting layer and a beam portion embedded in the current collecting layer. The first electrode layer includes an overlapping portion that overlaps the beam portion in a stacking direction, and a non-overlapping portion that does not overlap the beam portion in the stacking direction. The average particle size of Ni particles contained in the overlapping portion is smaller than the average particle size of Ni particles contained in the non-overlapping portion.

An electrochemical cell according to a second aspect of the present invention relates to the electrochemical cell according to the first aspect, wherein a first surface of the beam portion on the side opposite to the first electrode layer is covered with the current collecting layer.

An electrochemical cell according to a third aspect of the present invention relates to the electrochemical cell according to the first or second aspect, wherein a second surface of the beam portion facing the first electrode layer is covered with the current collecting layer.

An electrochemical cell according to a fourth aspect of the present invention relates to the electrochemical cell according to any one of the first to third aspects, wherein the support body has a frame body that surrounds a side periphery of the current collecting layer and to which the beam portion is coupled.

An electrochemical cell according to a fifth aspect of the present invention relates to the electrochemical cell according to any one of the first to fourth aspects, wherein the support body has a beam structural body constituted by a plurality of the beam portions.

An electrochemical cell according to a sixth aspect of the present invention relates to the electrochemical cell according to the fifth aspect, wherein the beam structural body has lattice structure.

An electrochemical cell according to a seventh aspect of the present invention relates to the electrochemical cell according to any one of the first to sixth aspects, wherein the porosity of the overlapping portion is greater than the porosity of the non-overlapping portion.

According to the present invention, it is possible to provide an electrochemical cell that is capable of suppressing warping.

### BRIEF DESCRIPTION OF DRAWINGS

FIG. 1 is a cross-sectional view of an electrolytic cell according to an embodiment.

FIG. 2 is a perspective view of a support body according to the embodiment.

FIG. 3 is a cross-sectional view of an electrolytic cell according to Modification 1.

FIG. 4 is a cross-sectional view of an electrolytic cell according to Modification 2.

### DESCRIPTION OF EMBODIMENTS

### Configuration of Electrolytic Cell 10

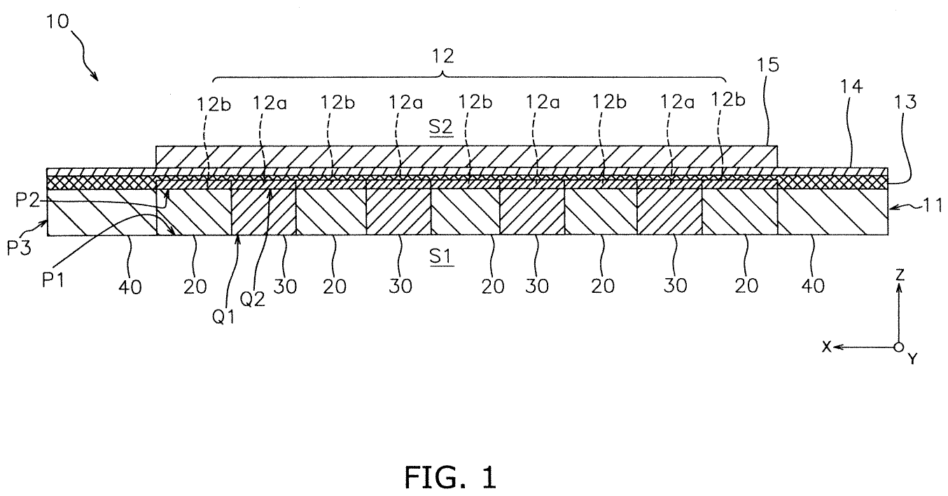

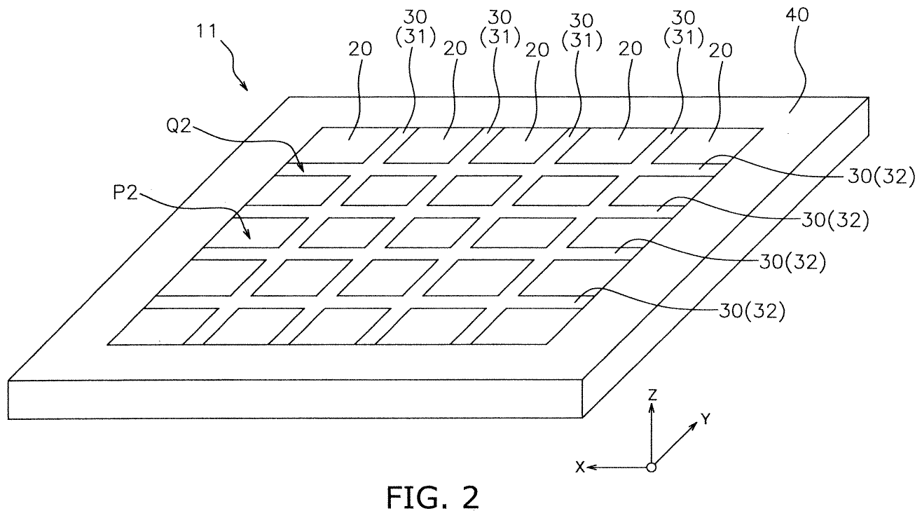

FIG. 1 is a cross-sectional view of an electrolytic cell 10 according to an embodiment. FIG. 2 is a perspective view of a support body 11 according to the embodiment. The electrolytic cell 10 is an example of an “electrochemical cell” according to the present invention.

As shown in FIG. 1, the electrolytic cell 10 includes a support body 11, a hydrogen electrode active layer 12, an electrolyte layer 13, a reaction prevention layer 14, and an oxygen electrode layer 15. The hydrogen electrode active layer 12 is an example of a “first electrode layer” according to the present invention. The oxygen electrode layer 15 is an example of a “second electrode layer” according to the present invention.

In the electrolytic cell 10, the support body 11, the hydrogen electrode active layer 12, the electrolyte layer 13, and the oxygen electrode layer 15 are essential components, whereas the reaction prevention layer 14 is an optional component.

The support body 11, the hydrogen electrode active layer 12, the electrolyte layer 13, the reaction prevention layer 14, and the oxygen electrode layer 15 are stacked in this order in a Z-axis direction. The Z-axis direction is perpendicular to an X-axis direction and a Y-axis direction. The Z-axis direction is an example of the “stacking direction” according to the present invention.

### Support Body 11

As shown in FIGS. 1 and 2, the support body 11 is formed in a plate shape. The support body 11 has a first main surface P1, a second main surface P2, and a side surface P3. The first main surface P1 is electrically connected to a separator not shown. The first main surface P1 faces a hydrogen electrode-side space S1 into which a raw material gas is supplied. The second main surface P2 is provided on the side opposite to the first main surface P1 in the Z-axis direction. The second main surface P2 is connected to the hydrogen electrode active layer 12. The side surface P3 is continuous with the first main surface P1 and the second main surface P2. The side surface P3 may be perpendicular to the first main surface P1 and the second main surface P2, or may be inclined with respect to the first main surface P1 and the second main surface P2.

The thickness of the support body 11 is not particularly limited, but may be 150 μm or more and 1000 μm or less, for example. In the Z-axis direction, the thickness of the support body 11 may be greater than the thicknesses of the hydrogen electrode active layer 12, the electrolyte layer 13, the reaction prevention layer 14, and the oxygen electrode layer 15.

As shown in FIGS. 1 and 2, the support body 11 has a hydrogen electrode current collecting layer 20, a beam structural body 30, and a frame body 40. The hydrogen electrode current collecting layer 20 is an example of a “current collecting layer” according to the present invention.

### Hydrogen Electrode Current Collecting Layer 20

The beam structural body 30 is embedded in the hydrogen electrode current collecting layer 20. In the present embodiment, the hydrogen electrode current collecting layer 20 is divided into small compartments by the beam structural body 30.

The hydrogen electrode current collecting layer 20 is supported by the beam structural body 30. In the present embodiment, the hydrogen electrode current collecting layer 20 is also supported by the frame body 40. The hydrogen electrode current collecting layer 20 functions as a support body for the electrolytic cell 10, together with the beam structural body 30 and the frame body 40. The electrolytic cell 10 according to the present embodiment is an electrode-supported electrochemical cell.

In addition to the current collecting function, the hydrogen electrode current collecting layer 20 has a gas diffusing function of diffusing the raw material gas supplied to the hydrogen electrode-side space S1 toward the hydrogen electrode active layer 12.

The hydrogen electrode current collecting layer 20 is a porous body having electron conductivity. The hydrogen electrode current collecting layer 20 contains nickel (Ni). In the case of co-electrolysis, Ni functions as an electron conductor and also functions as a thermal catalyst that promotes thermal reaction between H2 generated in the hydrogen electrode active layer 12 and CO₂ contained in the raw material gas to maintain a gas composition suitable for methanation and Fischer-Tropsch (FT) synthesis. The Ni contained in the hydrogen electrode current collecting layer 20 is basically present in the form of metallic Ni during the operation of the electrolytic cell 10, but a portion of it may be present in the form of nickel oxide (NiO).

The hydrogen electrode current collecting layer 20 may contain an ion conductive material. The ion conductive material may be any of yttria-stabilized zirconia (YSZ), calcia-stabilized zirconia (CSZ), scandia-stabilized zirconia (ScSZ), gadolinium-doped ceria (GDC), samarium-doped ceria (SDC), and a mixture of two or more of these materials.

The porosity of the hydrogen electrode current collecting layer 20 is not particularly limited, but can be 20% or more and 40% or less, for example.

The method for forming the hydrogen electrode current collecting layer 20 is not particularly limited, and may be any of sintering, spray coating (thermal spraying, aerosol deposition, aerosol gas deposition, powder jet deposition, particle jet deposition, cold spraying, and the like), PVD (sputtering, pulsed laser deposition, and the like), CVD, extrusion molding, tape molding, printing lamination, casting, dry pressing, and the like.

### Beam Structural Body 30

The beam structural body 30 supports the hydrogen electrode current collecting layer 20. The beam structural body 30 functions as a support body for the electrolytic cell 10, together with the hydrogen electrode current collecting layer 20 and the frame body 40.

The beam structural body 30 is embedded in the hydrogen electrode current collecting layer 20. In the present embodiment, the beam structural body 30 being embedded in the hydrogen electrode current collecting layer 20 means that at least a portion of the beam structural body 30 is buried in the hydrogen electrode current collecting layer 20.

The beam structural body 30 has a first surface Q1 and a second surface Q2.

The first surface Q1 is the surface of the beam structural body 30 opposite to the hydrogen electrode active layer 12. Specifically, the first surface Q1 is the surface of a first beam portion 31 and a second beam portion 32, which will be described later, opposite to the hydrogen electrode active layer 12. In the present embodiment, the first surface Q1 is not covered with the hydrogen electrode current collecting layer 20. That is, the first surface Q1 is exposed from the hydrogen electrode current collecting layer 20. Therefore, in the present embodiment, the first surface Q1 forms a portion of the first main surface P1 of the support body 11.

The second surface Q2 is the surface of the beam structural body 30 facing the hydrogen electrode active layer 12. Specifically, the second surface Q2 is the surface of the first beam portion 31 and the second beam portion 32, which will be described later, facing the hydrogen electrode active layer 12. In the present embodiment, the second surface Q2 is not covered with the hydrogen electrode current collecting layer 20. That is, the second surface Q2 is exposed from the hydrogen electrode current collecting layer 20. Therefore, in the present embodiment, the second surface Q2 forms a portion of the second main surface P2 of the support body 11, and is in direct contact with the hydrogen electrode active layer 12.

In the present embodiment, the beam structural body 30 has lattice structure in which a plurality of beam portions are arranged in a lattice pattern in the planar direction in planar view from the Z-axis direction. The lattice structure is structure in which a plurality of beam portions are periodically arranged in planar view from the Z-axis direction. Since the beam structural body 30 has lattice structure, the support body 11 as a whole can be improved in rigidity.

Although the beam structural body 30 according to the present embodiment has tetragonal lattice structure, the shape of the lattice structure is not particularly limited. The lattice structure may be vertical lattice structure, horizontal lattice structure, hexagonal lattice structure, or the like, for example.

The beam structural body 30 can be made of forsterite (Mg₂SiO₄), magnesium silicate (MgSiO₃), zirconia (ZrO₂, including partially stabilized zirconia), magnesia (MgO), magnesium alumina spinel (MgAl₂O₄), or a mixed material of two or more of these.

The porosity of the beam structural body 30 may be lower than the porosity of the hydrogen electrode current collecting layer 20. The porosity of the beam structural body 30 may be 0.1% or more and 15% or less, for example. The porosity of the beam structural body 30 is preferably 5% or less. This improves the strength of the beam structural body 30, thereby improving the rigidity of the support body 11 as a whole.

The electron conductivity of the beam structural body 30 may be lower than the electron conductivity of the hydrogen electrode current collecting layer 20. The beam structural body 30 may have electron insulation. The electron conductivity of the beam structural body 30 is not particularly limited, but may be 0.1 S/m or less.

As shown in FIG. 2, the beam structural body 30 is constituted by a plurality of beam portions. In the present embodiment, the beam structural body 30 is constituted by four first beam portions 31 and four second beam portions 32.

The first beam portions 31 and the second beam portions 32 are embedded in the hydrogen electrode current collecting layer 20. In the present embodiment, the first beam portions 31 being embedded in the hydrogen electrode current collecting layer 20 means that the first beam portions 31 are at least partially embedded in the hydrogen electrode current collecting layer 20. Similarly, the second beam portions 32 being embedded in the hydrogen electrode current collecting layer 20 means that the second beam portions 32 are at least partially embedded in the hydrogen electrode current collecting layer 20.

The first beam portions 31 and the second beam portions 32 are formed in a columnar shape. The first beam portions 31 and the second beam portions 32 extend along planar directions perpendicular to the Z-axis direction (stacking direction). In the present embodiment, the first beam portions 31 extend along the Y-axis direction, and the second beam portions 32 extend along the X-axis direction. Therefore, in planar view from the Z-axis direction, the angle formed by the second beam portions 32 with respect to the first beam portions 31 is 90 degrees. However, the angle formed by the second beam portions 32 with respect to the first beam portions 31 may be less than 90 degrees.

Both ends of each first beam portion 31 in the Y-axis direction are coupled to the frame body 40. The first beam portions 31 may be formed integrally with the frame body 40. Both ends of each second beam portion 32 in the X-axis direction are coupled to the frame body 40. The second beam portions 32 may be formed integrally with the frame body 40.

The beam structural body 30 according to the present embodiment has four first beam portions 31 and four second beam portions 32, but the number of first beam portions 31 and the number of second beam portions 32 are not particularly limited as long as they are one or more. The beam structural body 30 may have only either the first beam portions 31 or the second beam portions 32.

The method for forming the beam structural body 30 is not particularly limited, and may be extrusion molding, tape molding, printing lamination, casting, dry pressing, or the like.

As described above, since the support body 11 has at least either the first beam portions 31 or the second beam portions 32, the rigidity of the electrolytic cell 10 can be improved. Accordingly, it is possible to suppress warping of the electrolytic cell 10 caused by temperature rise and fall during reduction treatment or operation.

### Frame Body 40

The frame body 40 is formed in a frame shape. The frame body 40 surrounds the side peripheries of the hydrogen electrode current collecting layer 20 and the beam structural body 30. The side peripheries of the hydrogen electrode current collecting layer 20 and the beam structural body 30 refer to the peripheries of the side surfaces along the thickness direction. The frame body 40 functions as a support body for the electrolytic cell 10, together with the hydrogen electrode current collecting layer 20 and the beam structural body 30. In the present embodiment, the frame body 40 covers the entire side surfaces of the hydrogen electrode current collecting layer 20.

In the present embodiment, as shown in FIG. 2, the planar shape of the frame body 40 is rectangular. However, the planar shape of the frame body 40 may be circular, elliptical, or polygonal with three or more corners, in accordance with the planar shape of the hydrogen electrode current collecting layer 20.

The frame body 40 is coupled to the beam structural body 30. The frame body 40 may be formed integrally with the beam structural body 30.

The frame body 40 can be made of forsterite, magnesium silicate, zirconia, magnesia, magnesium alumina spinel, or a mixed material of two or more of these.

The porosity of the frame body 40 may be lower than the porosity of the hydrogen electrode current collecting layer 20. The porosity of the frame body 40 can be 0.1% or more and 15% or less, for example. The porosity of the frame body 40 is preferably 5% or less. This imparts gas sealing properties to the frame body 40, so as to suppress the case where the raw material gas flowing from the hydrogen electrode-side space S1 to the hydrogen electrode active layer 12 passes through the frame body 40 and returns to the hydrogen electrode-side space S1. This improves the efficiency of gas supply from the hydrogen electrode-side space S1 to the hydrogen electrode active layer 12.

The electron conductivity of the frame body 40 may be lower than the electron conductivity of the hydrogen electrode current collecting layer 20. The frame body 40 may have electron insulation. The electron conductivity of the frame body 40 is not particularly limited, but can be 0.1 S/m or less.

The method for forming the frame body 40 is not particularly limited, and may be extrusion molding, tape molding, printing lamination, casting, dry pressing, or the like.

### Hydrogen Electrode Active Layer 12

The hydrogen electrode active layer 12 functions as a cathode. The hydrogen electrode active layer 12 is disposed on the support body 11. The hydrogen electrode active layer 12 is covered with the electrolyte layer 13.

A raw material gas is supplied to the hydrogen electrode active layer 12 mainly via the hydrogen electrode current collecting layer 20 of the support body 11. In the present embodiment, the raw material gas contains at least H₂O.

If the raw material gas contains only H₂O, the hydrogen electrode active layer 12 generates H₂ from the raw material gas in accordance with the electrochemical reaction of water electrolysis shown in the following formula (1):

Hydrogen electrode active layer 12: H₂O+2e⁻→H₂+O²⁻ (1)

If the raw material gas contains CO₂ in addition to H₂O, the hydrogen electrode active layer 12 generates H₂, CO, and O²⁻ from the raw material gas in accordance with the co-electrochemical reactions shown in the following formulas (2), (3), and (4):

Hydrogen electrode active layer 12: CO₂+H₂O+4e⁻→CO+H₂+2O²⁻ (2)

Electrochemical reaction of H₂O: H₂O+2e⁻→H₂+O²⁻ (3)

Electrochemical reaction of CO₂: CO₂+2e⁻→CO+O²⁻ (4)

The hydrogen electrode active layer 12 is a porous body having electron conductivity. The hydrogen electrode active layer 12 contains nickel (Ni). In the case of co-electrolysis, Ni functions as an electron conductor and also functions as a thermal catalyst that promotes the thermal reaction between the generated H₂ and the CO₂ contained in the raw material gas to maintain a gas composition suitable for methanation and Fischer-Tropsch (FT) synthesis. The Ni contained in the hydrogen electrode active layer 12 is basically present in the form of metallic Ni during the operation of the electrolytic cell 10, but a portion of the Ni may be present in the form of nickel oxide (NiO).

The hydrogen electrode active layer 12 may contain an ion conductive material. The ion conductive material may be YSZ, CSZ, ScSZ, GDC, SDC, (La, Sr) (Cr, Mn) O₃, (La, Sr) TiO₃, Sr₂ (Fe, Mo) ₂O₆, (La, Sr) VO₃, (La, Sr) FeO₃, or a mixture of two or more of these.

The thickness of the hydrogen electrode active layer 12 is not particularly limited, but can be 5 μm or more and 50 μm or less, for example.

The method for forming the hydrogen electrode active layer 12 is not particularly limited, and may be sintering, spray coating (thermal spraying, aerosol deposition, aerosol gas deposition, powder jet deposition, particle jet deposition, cold spraying, and the like), PVD (sputtering, pulsed laser deposition, and the like), CVD, extrusion molding, tape molding, printing lamination, casting, dry pressing, or the like.

As shown in FIG. 1, the hydrogen electrode active layer 12 includes overlapping portions 12a and non-overlapping portions 12b.

The overlapping portions 12a are regions of the hydrogen electrode active layer 12 that overlap the first beam portions 31 or the second beam portions 32 of the beam structural body 30 in the Z-axis direction (stacking direction). In the planar directions perpendicular to the Z-axis direction, the positions of the overlapping portions 12a correspond to the positions of the first beam portions 31 or the second beam portions 32 of the beam structural body 30. In the present embodiment, the overlapping portions 12a are in direct contact with the second surface Q2 of the beam structural body 30.

The non-overlapping portions 12b are regions of the hydrogen electrode active layer 12 that do not overlap the first beam portions 31 or the second beam portions 32 of the beam structural body 30 in the Z-axis direction (stacking direction). In the planar direction perpendicular to the Z-axis direction, the positions of the non-overlapping portions 12b are away from the positions of the first beam portions 31 or the second beam portions 32 of the beam structural body 30. The non-overlapping portions 12b are not in contact with the second surface Q2 of the beam structural body 30.

As described above, since the support body 11 has at least either the first beam portions 31 or the second beam portions 32, the occurrence of warping in the electrolytic cell 10 can be suppressed. However, the raw material gas flowing from the hydrogen electrode-side space S1 toward the hydrogen electrode active layer 12 is blocked by the first beam portions 31 or the second beam portions 32. Therefore, the raw material gas is easily supplied to the non-overlapping portions 12b, but is relatively not easily supplied to the overlapping portions 12a. Accordingly, the electrode reaction occurs less easily in the overlapping portions 12a, thereby decreasing the overall performance.

In view of this, in the present embodiment, the average particle size of Ni particles contained in the overlapping portions 12a is made smaller than the average particle size of Ni particles contained in the non-overlapping portions 12b. This improves the electrode activity of the Ni particles, and the electrode activity in the overlapping portions 12a can be enhanced compared to the electrode activity in the non-overlapping portions 12b, so that it is possible to suppress a difference in the electrode reaction between the overlapping portions 12a and the non-overlapping portions 12b. Accordingly, the electrode reaction of the hydrogen electrode active layer 12 can be made uniform in the planar direction.

The average particle size of the Ni particles contained in the overlapping portions 12a is not particularly limited, but may be 3 μm or more and 10 μm or less. The average particle size of the Ni particles contained in the non-overlapping portions 12b is not particularly limited, but may be 2.4 μm or more and 8 μm or less.

The average particle sizes of the Ni particles contained in the overlapping portions 12a and the non-overlapping portions 12b are each calculated by the following method. First, a cross section of the hydrogen electrode active layer 12 along the thickness direction is exposed. Then, a composition mapping image of Ni on the cross section is obtained at 5000 to 10000-fold magnification using an SEM device (FE-SEM JSM-7900F manufactured by JEOL Ltd.) and an EDS device (JED-2300) attached to the SEM device. Next, the Ni composition mapping image is subjected to binarization processing in image analysis using image analysis software Image-Pro produced by Media Cybernetics, Inc., to thereby identify Ni particle portions in the Ni composition mapping image. Next, the diameter of a circle having the same area as that of each Ni particle in the binarized image is taken as the particle size of each Ni particle. The above processing is performed on 10 Ni particles randomly selected from each of five fields of view of the overlapping portions 12a, and the particle sizes of the 10 Ni particles are averaged to calculate the average particle size of the Ni particles contained in the overlapping portions 12a. Similarly, the particle sizes of 10 Ni particles randomly selected from one field of view of the non-overlapping portions 12b are averaged to calculate the average particle size of the Ni particles contained in the non-overlapping portions 12b.

The Ni content of the overlapping portions 12a is not particularly limited, but may be 20 vol % or more and 50 vol % or less. The Ni content of the non-overlapping portions 12b is not particularly limited, but may be 20 vol % or more and 50 vol % or less.

The porosity of the overlapping portions 12a is preferably greater than the porosity of the non-overlapping portions 12b. This improves gas diffusion in the overlapping portions 12a to which the raw material gas is less easily supplied from the hydrogen electrode current collecting layer 20 compared to the non-overlapping portions 12b to which the raw material gas is more easily supplied from the hydrogen electrode current collecting layer 20, and thus improves the electrode reaction at the overlapping portions 12a.

The porosity of the overlapping portions 12a is not particularly limited, but may be 25% or more and 45% or less, for example. The porosity of the non-overlapping portions 12b is not particularly limited, but may be 20% or more and 40% or less, for example.

The porosities of the overlapping portion 12a and the non-overlapping portion 12b are each calculated by the following method. First, a cross section of each hydrogen electrode active layer 12 along the thickness direction is exposed. Then, using the above-mentioned SEM device, backscattered electron images of the cross sections of the overlapping portion 12a and the non-overlapping portion 12b are obtained at 10,000-fold magnification. Next, using the image analysis software HALCON produced by MVTec Software GmbH, the parts displayed in black in the backscattered electron images (corresponding to pores) are identified. Then, the total area of the pores is divided by the total area of the backscattered electron image of the overlapping portion 12a to calculate the porosity of the overlapping portion 12a. Similarly, the total area of the pores is divided by the total area of the backscattered electron image of the non-overlapping portion 12b to calculate the porosity of the non-overlapping portion 12b.

### Electrolyte Layer 13

The electrolyte layer 13 is interposed between the hydrogen electrode active layer 12 and the oxygen electrode layer 15. In the present embodiment, the reaction prevention layer 14 is interposed between the electrolyte layer 13 and the oxygen electrode layer 15, so that the electrolyte layer 13 is interposed between the hydrogen electrode active layer 12 and the reaction prevention layer 14 and is connected to both the hydrogen electrode active layer 12 and the reaction prevention layer 14.

The electrolyte layer 13 covers the hydrogen electrode active layer 12. As shown in FIG. 1, the electrolyte layer 13 preferably covers the entire surface of the hydrogen electrode active layer 12.

The electrolyte layer 13 has the function of transmitting O²⁻ generated in the hydrogen electrode active layer 12 to the oxygen electrode layer 15. The electrolyte layer 13 is a dense body that has ion conductivity and has no electron conductivity. The electrolyte layer 13 can be made of YSZ, GDC, ScSZ, SDC, lanthanum gallate (LSGM), or the like, for example.

The porosity of the electrolyte layer 13 is not particularly limited, but may be 0.1% or more and 7% or less, for example. The thickness of the electrolyte layer 13 is not particularly limited, but may be 1 μm or more and 100 μm or less, for example.

The method for forming the electrolyte layer 13 is not particularly limited, and may be sintering, spray coating, PVD, CVD, or the like.

### Reaction Prevention Layer 14

The reaction prevention layer 14 is interposed between the electrolyte layer 13 and the oxygen electrode layer 15. The reaction prevention layer 14 is disposed on the side opposite to the hydrogen electrode active layer 12 with respect to the electrolyte layer 13. The reaction prevention layer 14 suppresses reaction of the constituent elements of the electrolyte layer 13 with the constituent elements of the oxygen electrode layer 15 to form a layer with high electrical resistance.

The reaction prevention layer 14 is made of an ion conductive material. The reaction prevention layer 14 can be made of GDC, SDC, or the like.

The porosity of the reaction prevention layer 14 is not particularly limited, but may be 0.1% or more and 50% or less, for example. The thickness of the reaction prevention layer 14 is not particularly limited, but may be 1 μm or more and 50 μm or less, for example.

The method for forming the reaction prevention layer 14 is not particularly limited, and may be sintering, spray coating, PVD, CVD, or the like.

### Oxygen Electrode Layer 15

The oxygen electrode layer 15 functions as an anode. The oxygen electrode layer 15 is disposed on the side opposite to the hydrogen electrode active layer 12 with respect to the electrolyte layer 13. In the present embodiment, since the reaction prevention layer 14 is interposed between the electrolyte layer 13 and the oxygen electrode layer 15, the oxygen electrode layer 15 is connected to the reaction prevention layer 14. If the reaction prevention layer 14 is not interposed between the electrolyte layer 13 and the oxygen electrode layer 15, the oxygen electrode layer 15 is connected to the electrolyte layer 13.

The oxygen electrode layer 15 generates O₂ from O²⁻⁰ transmitted from the hydrogen electrode active layer 12 through the electrolyte layer 13 according to the chemical reaction in Formula (5) below. The O₂ generated in the oxygen electrode layer 15 is released into the oxygen electrode-side space S2.

Oxygen electrode layer 15: 2O²⁻→O₂+4e⁻ (5)

The oxygen electrode layer 15 is a porous body having ion conductivity and electron conductivity. The oxygen electrode layer 15 can be made of a composite material of one or more of (La, Sr) (Co, Fe) O₃, (La, Sr) FeO₃, La (Ni, Fe) O₃, (La, Sr) CoO₃, and (Sm, Sr) CoO₃ with an ion conductive material (such as GDC).

The porosity of the oxygen electrode layer 15 is not particularly limited, but may be 20% or more and 60% or less, for example. The thickness of the oxygen electrode layer 15 is not particularly limited, but may be 1 μm or more and 100 μm or less, for example.

The method for forming the oxygen electrode layer 15 is not particularly limited, and may be sintering, spray coating, PVD, CVD, or the like.

### Modifications of Embodiments

Although embodiments of the present invention have been described above, the present invention is not limited to these, and various modifications are possible without departing from the spirit of the present invention.

### Modification 1

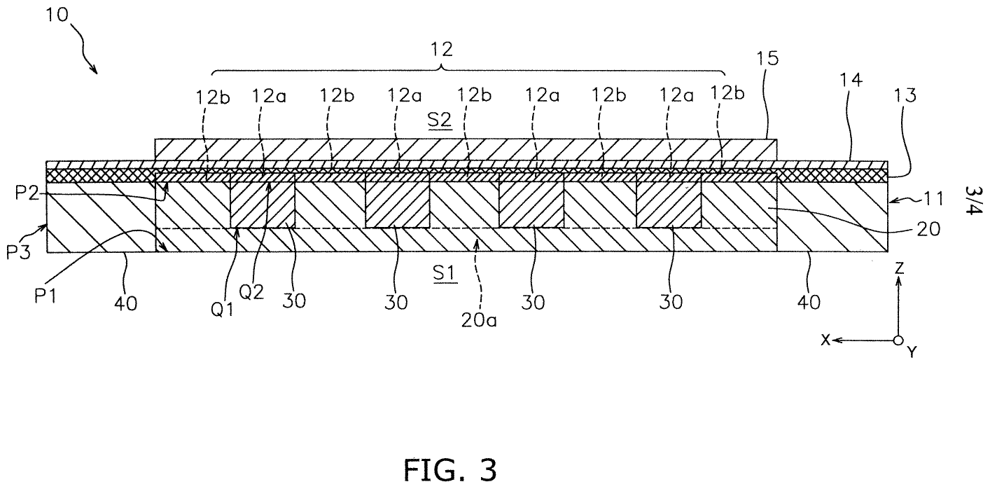

In the above-described embodiments, the first surface Q1 of the beam structural body 30 (specifically, the first and second beam portions 31 and 32) is not covered with the hydrogen electrode current collecting layer 20. However, as shown in FIG. 3, the first surface Q1 may be covered with the hydrogen electrode current collecting layer 20. Accordingly, a portion of the hydrogen electrode current collecting layer 20 is formed as an outer layer-shaped portion 20a on the side opposite to the hydrogen electrode active layer 12 with respect to the beam structural body 30. This suppresses the blocking of a flow of electrons between the hydrogen electrode current collecting layer 20 and the separator (not shown) by the beam structural body 30.

### Modification 2

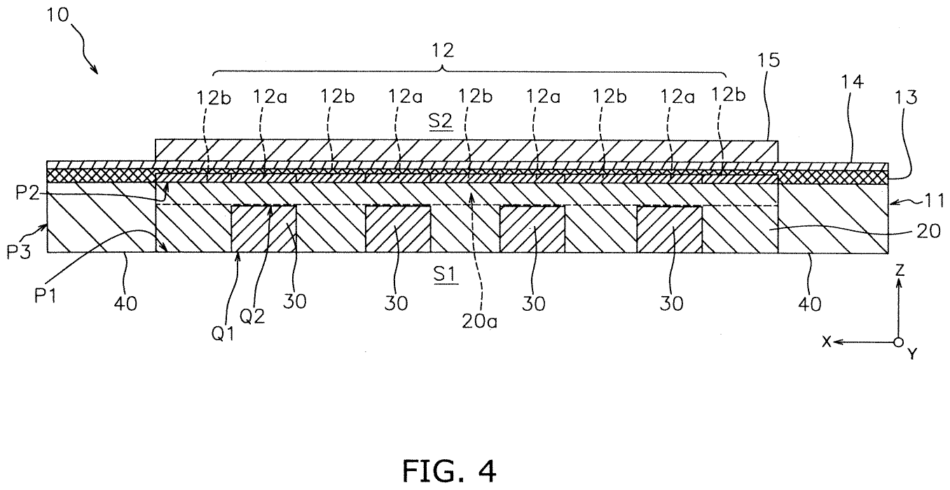

In the above-described embodiments, the second surface Q2 of the beam structural body 30 (specifically, the first and second beam portions 31 and 32) is not covered with the hydrogen electrode current collecting layer 20 but is in direct contact with the hydrogen electrode active layer 12 (specifically, the overlapping portions 12a). However, as shown in FIG. 4, the second surface Q2 may be covered with the hydrogen electrode current collecting layer 20. Accordingly, a portion of the hydrogen electrode current collecting layer 20 is formed as an inner layer-shaped portion 20b between the beam structural body 30 and the hydrogen electrode active layer 12. This improves the function of gas diffusion from the hydrogen electrode current collecting layer 20 to the hydrogen electrode active layer 12.

### Modification 3

In the above-described embodiments, the frame body 40 surrounds the side peripheries of the hydrogen electrode current collecting layer 20 and the beam structural body 30. In addition, the frame body 40 may also surround the side periphery of the hydrogen electrode active layer 12, and may further surround the side periphery of the electrolyte layer 13.

### Modification 4

In the above-described embodiments, the support body 11 has the frame body 40. However, the support body 11 may not have the frame body 40. In this case, the hydrogen electrode current collecting layer 20 and the beam structural body 30 function as the support body for the electrolytic cell 10.

### Modification 5

In the above-described embodiments, the hydrogen electrode active layer 12 functions as the cathode, and the oxygen electrode layer 15 functions as the anode. Alternatively, the hydrogen electrode active layer 12 may function as the anode, and the oxygen electrode layer 15 may function as the cathode. In this case, the constituent materials of the hydrogen electrode active layer 12 and the oxygen electrode layer 15 are interchanged, and the raw material gas is passed over the outer surface of the hydrogen electrode active layer 12. The hydrogen electrode current collecting layer 20 functions as the oxygen electrode current collecting layer, but the configuration and function of the oxygen electrode current collecting layer are the same as those of the hydrogen electrode current collecting layer 20 in the above-described embodiments.

### Modification 6

In the above-described embodiments, the electrolytic cell 10 is an example of an electrochemical cell. However, the electrochemical cell is not limited to an electrolytic cell. “Electrochemical cell” is a general term for elements in which a pair of electrodes are arranged such that an electromotive force is generated from an overall oxidation-reduction reaction in order to convert electrical energy into chemical energy, and elements that convert chemical energy into electrical energy. Therefore, electrochemical cells include fuel cells that use oxide ions or protons as carriers, for example.

### REFERENCE SIGNS LIST

10 Electrolytic cell
11 Support body
12 Hydrogen electrode active layer
12a Overlapping portion
12b Non-overlapping portion
13 Electrolyte layer
14 Reaction prevention layer
15 Oxygen electrode layer
20 Hydrogen electrode current collecting layer
30 Beam structural body
40 Frame body
50 Through hole
P1 First main surface of support body
P2 Second main surface of support body
Q1 First surface of beam portion
Q2 Second surface of beam portion

1. An electrochemical cell comprising:
a support body;
a first electrode layer disposed on the support body;
an electrolyte layer disposed on the first electrode layer; and
a second electrode layer disposed on a side opposite to the first electrode layer with respect to the electrolyte layer, wherein
the support body has a current collecting layer and a beam portion embedded in the current collecting layer,
the first electrode layer includes an overlapping portion and a non-overlapping portion, the overlapping portion overlapping the beam portion in a stacking direction, and the non-overlapping portion not overlapping the beam portion in the stacking direction, and
an average particle size of Ni particles contained in the overlapping portion is smaller than an average particle size of Ni particles contained in the non-overlapping portion.

2. The electrochemical cell according to claim 1, wherein
a first surface of the beam portion on a side opposite to the first electrode layer is covered with the current collecting layer.

3. The electrochemical cell according to claim 1, wherein
a second surface of the beam portion facing the first electrode layer is covered with the current collecting layer.

4. The electrochemical cell according to claim 1, wherein
the support body has a frame body, the frame body surrounding a side periphery of the current collecting layer and being coupled to the beam portion.

5. The electrochemical cell according to claim 1, wherein
the support body has a beam structural body constituted by a plurality of the beam portions.

6. The electrochemical cell according to claim 5, wherein
the beam structural body has lattice structure.

7. The electrochemical cell according to claim 1, wherein
a porosity of the overlapping portion is greater than a porosity of the non-overlapping portion.
